(19) United States
(12) Patent Application Publication
(10) Pub. No.: US 2002/0131616 A1
(43) Pub. Date: Sep. 19, 2002

(54) Apparatus and methods for sound reproduction and recording

(76) Inventors: Andrei M. Bronnikov, Los Angeles, CA (US); Mark T. Anikst, Santa Moniea, CA (US); Ivan Perez-Mendez, Boulder, CO (US); David J. Trawick, Longmont, CO (US); John J. Turley, Santa Monica, CA (US); Daniel A. Estoque, Boulder, CO (US); James M. Burry, Loveland, CO (US)

Correspondence Address: IP PATENTS, FAEGRE & BENSON LLP, 1900 FIFTEENTH STREET, BOULDER, CO, 80302, US

(21) Appl. No.: 09/853,148

(22) Filed: May 9, 2001

Related U.S. Application Data
(60) Provisional application No. 60/249,310, filed on Nov. 16, 2000.

(51) Int. Cl. H04B 1/38; H04R 25/00

(52) U.S. Cl. 381/370; 381/371; 381/374; 381/375; 381/376; 381/378

(57) ABSTRACT

A combination hat and headset device (the “hatset”) for improved comfort, hygiene, and consistent microphone placement. The headset is a combination of speaker(s) or microphone(s) for use in communicating with some other system, such as a telephone or computer system. The hat supports the weight of the headset and provides a buffer between the headset and the user. The hat is separable from the headset, so it can be washed independently of the headset. The hat and headset are easily separable, so the hat may be user-specific while the headset is shared among multiple users. The headset is specifically designed to be able to fit any head, with several independent adjustments available for variations in ear and mouth shape, size, and position, and head proportions. The microphone boom is designed to be temporarily movable away from the user's mouth, and then rapidly and accurately restored to a formerly selected position.

This patent application claims the benefit of U.S. Provisional Application No. 60/249,310, filed on Jul. 14, 2000.

### BACKGROUND OF THE INVENTION

1. Field of the Invention

The present invention relates generally to apparatus and methods for transforming electrical reproductions of sound into audible sound itself or vice versa. More particularly, the field of the invention relates to headsets, which typically comprise a combination of speakers and a microphone configured to be placed on a user's head in such a manner that the speakers are in close proximity to the user's ears and the microphone is in close proximity to the user's mouth.

2. Description of the Prior Art

Headsets are useful in a variety of applications. They generally comprise one or more speakers and a microphone in a configuration wearable on the head. Generally, speaker and microphone combinations are used in many kinds of communication systems. The communication system may be from one person to another, such as by telephone, radio, or intercom. Alternatively, the communication may be between a person and a computer system, with the computer system using speech recognition and text-to-speech or playback of pre-recorded speech for its user interface. In some instances, a user of one of these systems speaks into the microphone and listens to the sound that comes out of the speaker(s). Mounting these elements together on a headset allows the user's hands to stay free for other tasks. It also allows the user to talk and listen naturally, as if the other party was located within speaking distance.

Of necessity, headsets have to attach to the head of the user and distribute their weight in some way. Some have a band that clamps over the head. One or both ends of this band may be connected to a speaker covering the ear, exerting pressure on the ear. Other headsets rest on the external part of the ear like eyeglasses. Still others are pushed inside the ear. During extended wear, all of these headsets become uncomfortable. Furthermore, if the environment is warm or the headset user is engaged in manual labor, the user may sweat into the headset, discouraging or preventing sharing of the device among different users. Also, no one would want to share a headset with someone else who was ill.

People frequently wear hats or other head apparel all day long without any comfort problems. Thus it is natural that attempts have been made to combine headsets with a variety of headwear: hats, headbands, earmuffs, eyeglasses, visors, helmets. U.S. Pat. No. 5,881,390 teaches inserting speakers into a flexible headband, which may be attached to a hat or bandanna. U.S. Pat. No. 5,257,420 teaches inserting speakers into earmuffs. U.S. Pat. No. 5,164,987 teaches attaching speakers to the earpieces of eyeglasses. U.S. Pat. No. 5,265,165 teaches attaching pockets to a visor for speakers. U.S. Pat. No. 6,075,857 teaches attaching a headset inside a motorcycle helmet. Each of these embodiments provides the benefit of making the headset somewhat more comfortable, given the comfort issues of the original headsets. But none provide hygienic separation of the user from the headset elements. Nor do they provide rapid separation of the hat or head apparel from the headset elements for sharing of the headset among multiple users.

Existing headsets sometimes allow adjustments in several dimensions to permit use with many head sizes and shapes. But there is enough variation in the size, shape, and position of ears and mouths that many people must wear headsets in a poorly adjusted manner. The speaker may not fit correctly over the ear, or may compress part of the ear. The microphone may not reach the mouth, or may go too far beyond the mouth for good input. Any poor adjustment will make the user less comfortable, and will also degrade the fidelity of the headset. Any poor adjustment will become more uncomfortable over time.

Many attempts have been made to design a headset that more comfortably fits more users by varying the ways in which the headset can be adjusted. For example, U.S. Pat. No. 5,469,505 teaches using a headset with a ball-joint mounted speaker, for more variation in ear position. U.S. Pat. No. 5,381,486 teaches using a headset with a universal joint mounted microphone boom, for more variation in mouth position. While these embodiments offer more degrees of freedom than the usual headset, there remains a need for a headset where each working element, the microphone and the speakers, can be placed independently of one another.

Consistent headset positioning is necessary for optimal performance. Microphone positioning is especially important when a headset is used as part of a speech recognition system. But with a headset correctly in position, the mouth and ear(s) are effectively blocked. Thus to get a drink or to scratch the ear, the headset must be moved out of position. The user must then reposition the headset for optimal performance. In existing headsets this requires making the same adjustments that were required when putting on the headset initially. Such a readjustment will rarely return the headset to the original position.

Some headset users simply remove the headset when temporarily not in use. U.S. Pat. No. 5,960,094 teaches using a headset resting on top of the ear that rotates out of the way when not in use, so the user does not need to remove the headset. However, this rotation away from the head leaves the headset in a precarious position. Furthermore, after moving the headset out of the way, the process of repositioning the headset is the same as the original adjustment process for the headset.

Against this background, the subject matter of this application has been developed to solve the problems of the prior art and to provide for a more comfortable and hygienic headset with better and more consistent placement and replacement of the headset elements.

### SUMMARY OF THE INVENTION

To achieve the forgoing and other objects and in accordance with the purposes of the present invention, as embodied and broadly described herein, the present invention is directed to a combination hat and headset, termed a “hatset,” for improved comfort, hygiene, and microphone positioning. The hat part of the hatset is worn like any other hat, is adjustable to fit essentially any size adult human head, supports the weight of the headset part, distributes the weight of the headset part over the contact area of the hat part with the user, is securely attachable to the headset part, is easily and rapidly separable from the headset part, and hygienically isolates the user from the headset part.

Further, the headset part of the hatset is adjustable to fit essentially any size adult human head, and has a microphone boom that can be moved from its adjusted position to a temporary not in use position and then rapidly and accurately returned to its adjusted in use position.

Accordingly, it is an object of the present invention to provide a headset for improved comfort, hygiene, and consistent microphone placement.

It is also an object of the present invention to provide a headset consisting of a hat part and a headset part, securely attachable to each other, where the headset part consists of the speaker(s), microphone(s), and mounting and connecting hardware, electronics, and wiring.

Another object of the present invention is to provide a headset that a user can wear like a hat, with the headset part supported by the hat part and the hat part supported by the user.

A further object of the present invention is to provide a headset that uses the hat part to keep the user separate from the headset part.

It is another object of the present invention to provide a headset with a hat part that is easily separable from the headset part, so that the hat part may be user-specific and the headset part may be shared among multiple users.

Yet another object of the present invention is to provide a headset that may be adjusted to fit properly on a greater variety of adult human head sizes and shapes, and ear and mouth sizes and positions.

Still another object of the present invention is to provide a headset with a microphone boom that can be adjusted for a user, then moved out of the way, then rapidly and accurately restored to its previously adjusted in-use position.

Additional objects, advantages and novel features of this invention shall be set forth in part in the description that follows, and in part will become apparent to those skilled in the art upon examination of the following specification or may be learned by practice of the invention. The objects and advantages of the invention may be realized and attained by means of the apparatus and methods particularly pointed out in the appended claims.

### BRIEF DESCRIPTION OF THE DRAWINGS

The accompanying drawings, which are incorporated in and form a part of this application, illustrate the preferred embodiments of the present invention, and together with the descriptions serve to explain the principles of the invention.

FIG. 1 is a perspective view of the hatset of this invention, showing one possible combination of hat and headset.

FIG. 2 is a side view of the hatset of this invention.

FIG. 3 is a front view of the hatset of this invention.

FIG. 4 is an exploded view of the hatset of this invention.

FIG. 5 shows the hat and headset connection of the hatset of this invention.

FIG. 6 shows the earpiece and the earpiece adjustments of the hatset of this invention.

FIG. 7 shows the microphone boom and the microphone boom adjustments of the hatset of this invention.

FIG. 8 shows the buttons on the hatset of this invention.

FIG. 9 shows an alternative use of the headset part of the hatset of this invention, without the hat.

### DETAILED DESCRIPTION OF THE PREFERRED EMBODIMENTS

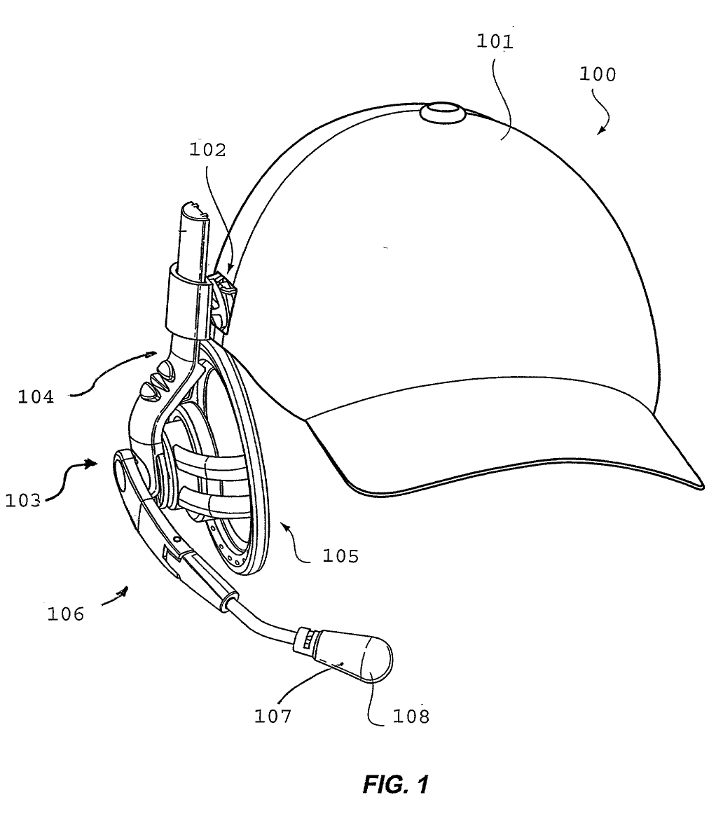

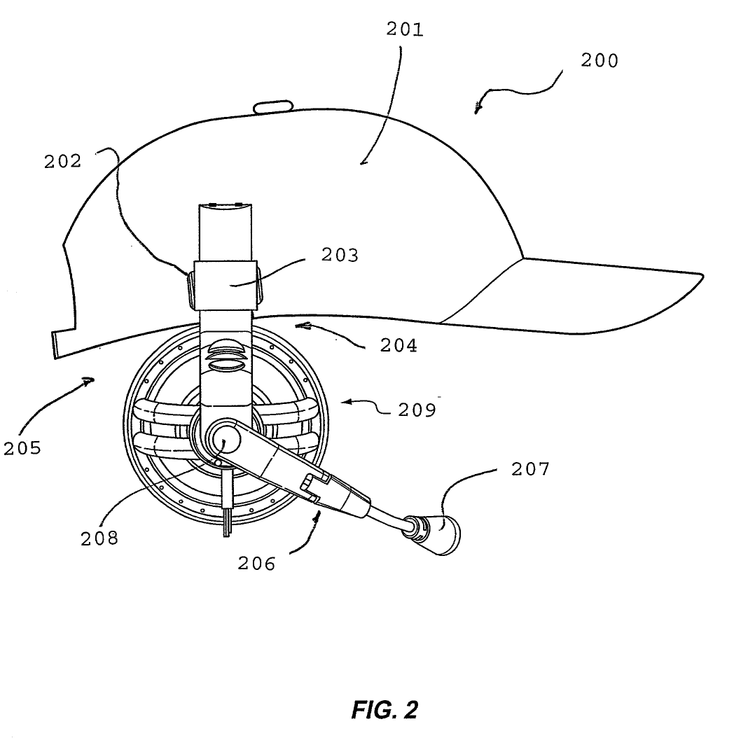

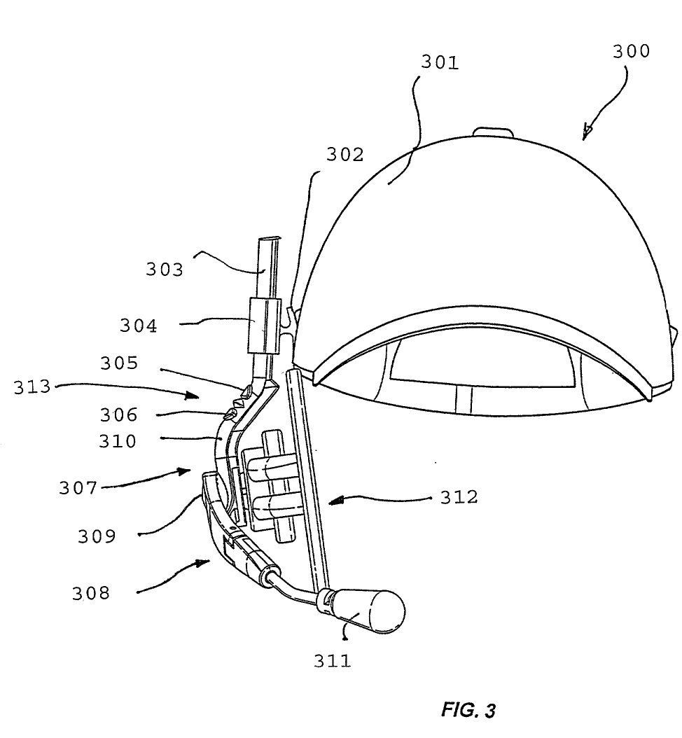

FIG. 1, FIG. 2, and FIG. 3 show a preferred embodiment of the complete hatset 10 in accordance with the present invention. FIG. 1 shows an overall perspective view of the complete hatset 100. The hatset 100 is comprised of the hat 101, the hat insert assembly 102, and the headset 103. The headset 103 is comprised of the earpiece support assembly 104, the earpiece assembly 105, and the microphone boom assembly 106. The wind screen 108 covers the microphone 107. Both parts are attached to the end of the microphone boom assembly 106.

FIG. 2 shows a side view of the hatset 200 of FIG. 1. The hatset 200 is comprised of the hat 201, the hat insert assembly 202 and the headset 205. The headset 205 is comprised of the earpiece support assembly 204, the earpiece assembly 209 and the microphone boom assembly 206. The wind screen and microphone 207 are attached to the end of the microphone boom assembly 206. The microphone boom assembly rotates about pivot 208 relative to the other parts of the hatset 200.

FIG. 3 shows a front view of the hatset 300 of FIG. 1. The hatset 300 is comprised of the hat 301, the hat insert assembly 302 and the headset 307. The headset 307 is comprised of the earpiece support assembly 313, the earpiece assembly 312 and the microphone boom assembly 308. The wind screen and microphone 311 are attached to the end of the microphone boom assembly 308. The top portion 303 of the earpiece support assembly 313 slides into the earpiece support guide 304, thereby attaching the earpiece support assembly 313 to the hat insert assembly 302. The earpiece support assembly 313 includes the earpiece support arm 310 which houses buttons 305, 306 which are located on the external side of the earpiece support arm 310. The microphone boom assembly 310 rotates about pivot 309.

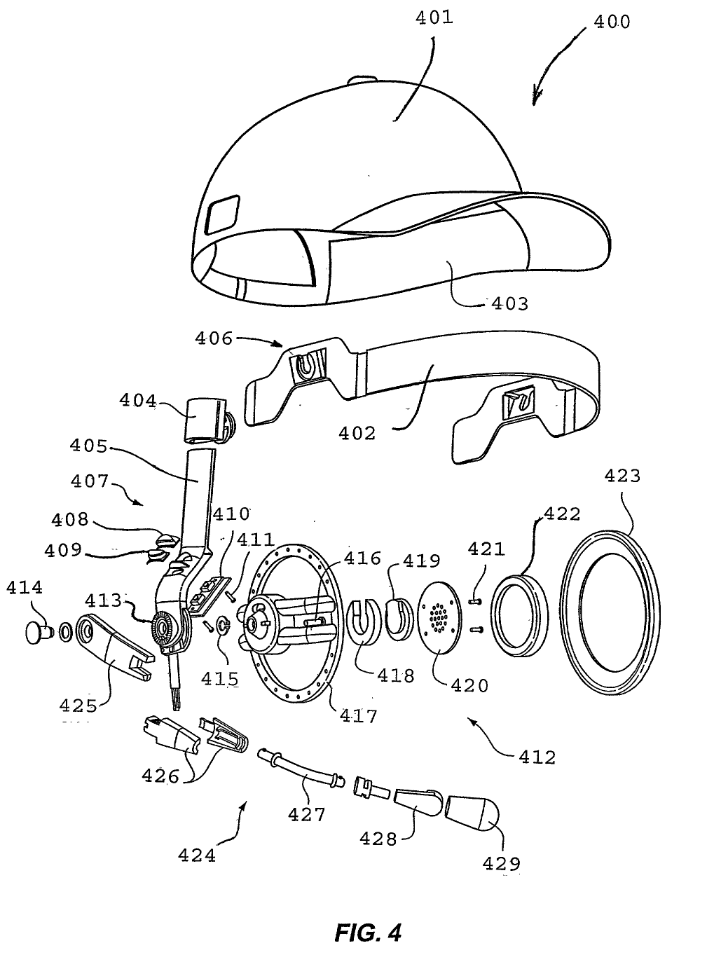

FIG. 4 is an exploded view of the hatset 400 of the previous figures, displaying how the hatset 400 is assembled. The hat 401 is securely attached to the hat insert assembly 402. The hat insert band 402 may be inserted into a hat sleeve 403 in the hat 401. Alternatively, the hat 401 is attached to the hat insert band 402 with hat loops (not shown). The hat sleeve may be in the interior or exterior of the hat 401. The earpiece support guide 404 is attached to the hat insert band 402.

The earpiece support assembly 405 slides into the earpiece support guide 404, thereby attaching the earpiece support assembly 405 to the hat insert assembly 406. The earpiece support assembly 405 is comprised of the earpiece support arm 407 which houses two buttons 408, 409. Buttons 408, 409 are located on the external side of the earpiece support arm 407. The button printed circuit board (PCB) assembly 410 implements the electrical requirements for the buttons. The button PCB assembly 410 is located in the earpiece support arm 407, attached by means of the button PCB assembly screws 411.

The earpiece assembly 412 attaches to the earpiece support assembly 405 by components comprising a retaining ring 415 and an inner earpiece screw 416. The earpiece support arm 407 is attached to the upper microphone boom 425 by pivot 413. Both upper microphone boom 425 and support arm 407 are fitted with circular ratchets 413, which control pivotal movement of upper microphone boom 425 by permitting rotation in discrete increments dictated by the spacing of the teeth on the ratchets. This, for example, permits the microphone boom assembly 424 to be moved away from a particular position in front of a user's mouth and then returned precisely to original its position in front of the user's mouth. This feature is important, for example, in speech recognition applications.

The microphone boom assembly 424 attaches to the earpiece support assembly 405 at the same place as the earpiece assembly 412, by means of the earpiece coupling 413. The microphone boom assembly 424 is comprised of the upper microphone boom 425, and lower microphone boom 426, the end boom 427, the microphone 428, and the microphone wind screen 429.

The inner earpiece screw 416 attaches the earpiece housing 417 to the earpiece support assembly 405. Attached to the earpiece housing 417 are the isolation foam 418, the speaker 419, and the speaker grill 420, all secured by means of the speaker grill screws 421. The inner comfort pad 422 attaches to the speaker grill 420. The outer comfort pad 423 attaches to the earpiece housing 417. An optional earpiece noise shield (not shown), for high noise environments, attaches between the earpiece housing 417 and the isolation foam 418 when in use.

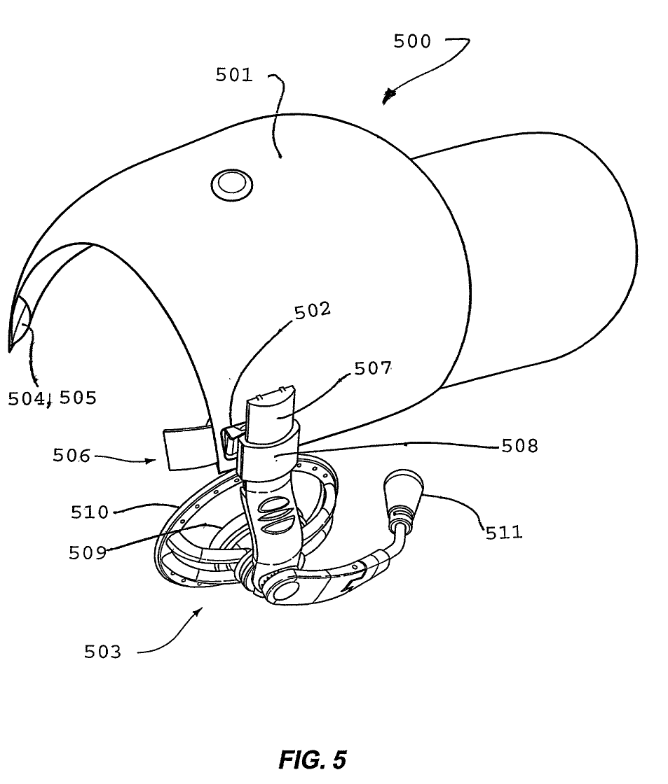

FIG. 5 displays the means by which the hatset 500 is attached to the hat insert assembly 502, and thereby to the headset 503. The hat loops 504 or the hat sleeve 505 are secured to the hat 501, and define a specific position for the hat insert band 506 to be attached to the hat 501. The hat insert band 506 and the hat 501 then move together as a unit. The weight of the hatset 500 apart from the hat 501 rests on the hat 501.

The hat insert assembly 502 forms a boundary between the hat 501 and the headset 503. The hat 501 may be separated from the headset 503 either by separating the hat 501 from the hat insert assembly 502, or by separating the hat insert assembly 502 from the headset 503. The hat 501 is separated from the hat insert assembly 502 by detaching the hat insert band 506 from the hat 501. The headset 503 is separated from the hat insert assembly 502 by removing the earpiece support arm 507 from the earpiece support guide 508. Furthermore, separating the earpiece support guide 508 from the hat insert band 506 may separate the hat 501 from the headset 503.

Hygienic isolation of the user from the headset 503 is accomplished by means of the hat 501, and also the inner comfort pad 509, the outer comfort pad 510, and the microphone wind screen 511. The hat 501, the inner comfort pad 509, the outer comfort pad 510, and the microphone wind screen 511 are meant to be user specific and are not to be shared among multiple users, even when the headset 503 is shared among multiple users.

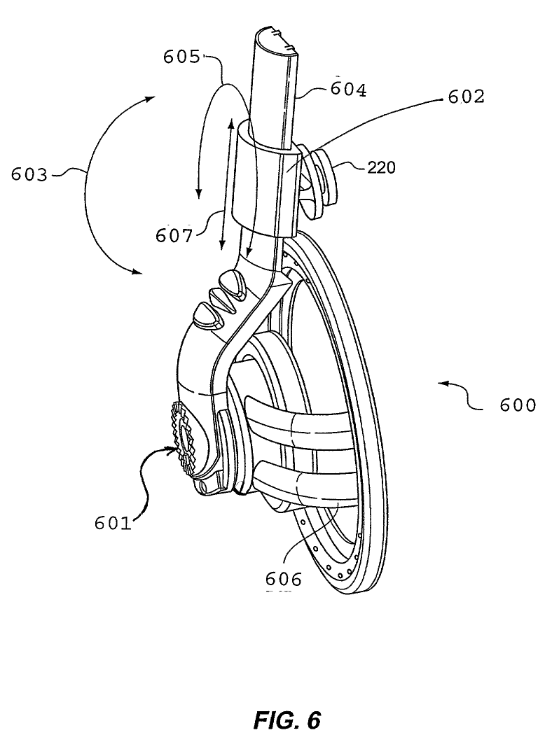

FIG. 6 displays the adjustments available for the earpiece assembly 600 for positioning the speaker 601 correctly over the user's ear. These adjustments take place at the earpiece support guide 602. The earpiece support arm 604 may be adjusted along bi-directional arrow 607, sliding in or out of the earpiece support guide 602, to change the distance from the earpiece support guide 602 to the end of the earpiece support arm 604. The earpiece support guide 602 may be rotated along bi-directional arrow 605 to adjust the angle the earpiece support arm 604 makes with a vertical line through the ear in the approximate plane of the side of the face.

Furthermore, the earpiece support guide 602 may be rotated along bi-directional arrow 603. This is accomplished by means of the weight of the headset, which keeps the earpiece assembly 600 and the speaker 601 positioned over the ear of the user. The earpiece housing 606 is designed to be large enough to fit over essentially any human adult external ear. The extent of the adjustment motions along bi-directional arrows 607, 605, and 603 are designed to be large enough to place the earpiece assembly 600 over essentially any human adult external ear position.

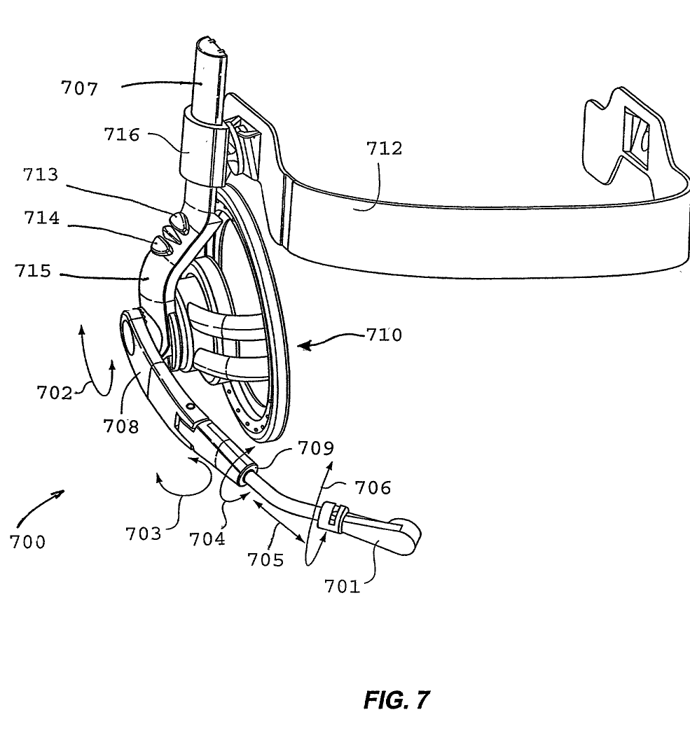

FIG. 7 displays the adjustments available for the microphone boom assembly 700 for positioning the microphone 701 correctly in place by the user's mouth. The microphone boom assembly 700 may be adjusted along any of the bi-directional arrows 702, 703, 704, 705 and 706. The microphone 701 is typically a directional microphone for use with a speech recognition system. This requires that the microphone 701 be adjusted not only for position, but also for orientation, so that speech from the mouth is directed toward the input direction of the microphone 701, typically by orienting the speech direction to be perpendicular to the plane of the microphone 701. The five adjustments along the bi-directional arrows 702,703,704,705 and 706 are used to position the microphone 701 and orient the microphone 701 for best directional sensitivity to the input speech from the user. The extent of the adjustments along bi-directional arrows 702,703,704,705 and 706 are designed to be large enough to place the microphone 701 correctly in front of any human adult mouth.

FIG. 7 also shows how the microphone boom assembly 700 may be temporarily removed from the speaking position and then rapidly restored to the correct speaking position. Adjustments along the bi-directional arrow 702 move the microphone 701 away from the user's mouth without changing the other adjustments along bi-directional arrows 703,704,705 and 706. There are circular ratchets at the junction between the earpiece support arm 707 and the microphone upper boom 708, which define the adjustment positions along bi-directional arrow 702. If the microphone boom assembly 700 is moved along bi-directional arrow 702 to a vertical position, the microphone boom assembly 700 will be completely clear of the mouth. To return the microphone boom assembly 700 to its correct in-use position, the microphone boom assembly is rotated back along bi-directional arrow 702 toward the mouth. Once the microphone boom assembly 700 is near the original adjusted position, a detent will guide the microphone boom assembly 700 back into the exact original position.

Also, adjustments along the bi-directional arrow 703 move the microphone 701 away from the user's mouth without changing the other adjustments along bi-directional arrows 702, 704, 705 and 706. There are circular ratchets at the junction between the microphone upper boom 708 and the microphone lower boom 709, which define the adjustment positions along bi-directional arrow 703. If the microphone boom assembly 700 is moved along bi-directional arrow 703 to a position away from the face, the microphone boom assembly 700 will be completely clear of the mouth. To return the microphone boom assembly 700 to its correct in-use position, the microphone boom assembly is rotated back along bi-directional arrow 703 toward the mouth. Once the microphone boom assembly 700 is near the original adjusted position, a detent will guide the microphone boom assembly 700 back into the exact original position.

An adjustment along bi-directional arrow 702 is also used to switch the headset 710 from right-handed (over the right ear) to left-handed (over the left ear). First, the microphone boom assembly 700 is moved along bi-directional arrow 702 from the right side of the earpiece assembly 710 to the left side of the earpiece assembly 710. Then the earpiece support guide 716 is removed from the right side of the hat insert band 712 and reattached to the left side of the hat insert band 712. Then the hatset is in position to be used in a left-handed manner (over the left ear).

FIG. 7 shows how the buttons, button 713 and button 714, on the earpiece support 715 are easily distinguished. The hatset has two buttons, button 713 and button 714. The buttons are positioned above and below each other on the earpiece support arm 715 with a ridge in between them so that they may be easily distinguished. They are designed to be big enough to be found on the earpiece support arm 715 by a user, even if the user is wearing thick gloves. Button 713 is the first button found by tracing down the earpiece support arm 715 from the top, where the earpiece support arm 715 attaches to the earpiece support guide 716. Button 714 is the first button found by tracing up the earpiece support arm 715 from the bottom, where the earpiece support arm 715 attaches to the earpiece assembly 710 and the microphone boom assembly 700.

The buttons, button 713 and button 714, are electric push buttons that may be used to send a signal to the system using the hatset. For example, a speech recognition system may use a button press as a signal to start or stop listening, or to transition from an active mode to a standby mode. For another example a telephone system may use a button press to indicate the termination (hang up) of a call.

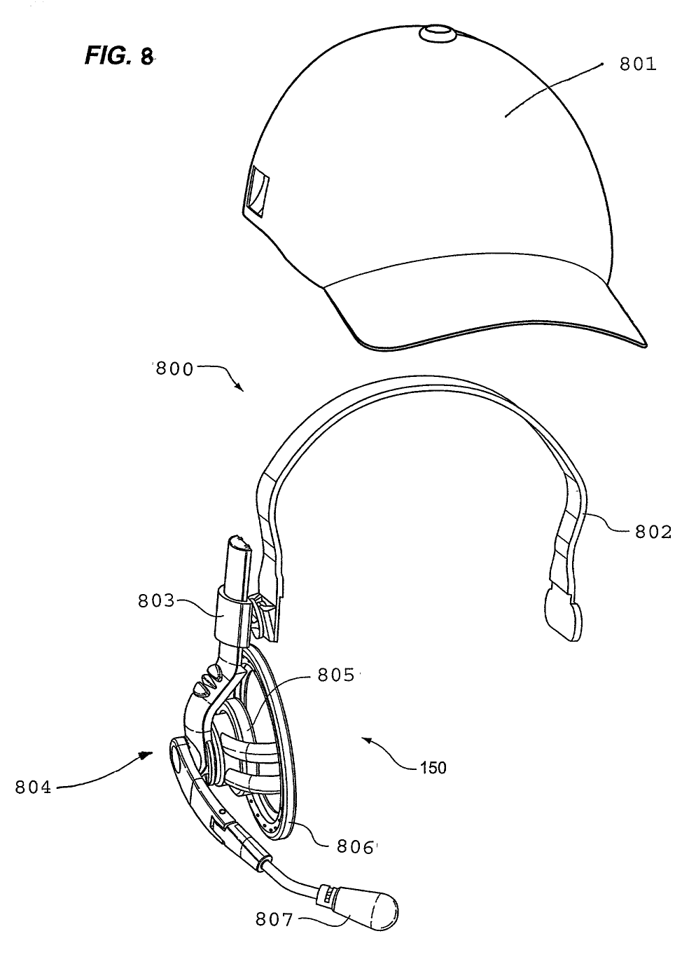

FIG. 8 shows an alternative embodiment of the hatset 800 without the hat 801, using the hat insert band 802 for support of the remaining hatset 800. The hat insert band 802 may be separated from the hat 801 and used to mount the remaining hatset 800 on the user's head. The hat insert band 802 is positioned over the head in this case. Here the hat insert band 802 is not kept hygienically separate from the user. However, the earpiece support guide 803 and the rest of the headset 804 are kept hygienically separate from the user, except for the inner comfort pad 805, the outer comfort pad 806, and the microphone wind screen 807, as usual.

While the exemplary preferred embodiments of the present invention have been described in detail, those skilled in the art will recognize various changes, modifications, additions, and applications other than those specifically mentioned herein which fall within the spirit of this invention.

What is claimed is:

1. A hatset for converting electrical signals into corresponding audible signals comprising:
a hat worn by a human user; and
at least one electrical transducer for converting an electrical signal into corresponding sounds audible to the wearer of said hat.

2. The hatset of claim 1 wherein said hat is configured to fit said head of said user.

3. The hatset of claim 1 wherein said hat is configured to fit at least two different sizes of user heads.

4. The hatset of claim 1 wherein said transducer is supported by a headset that encircles said head of said user.

5. The hatset of claim 2 wherein said hat supports the weight of said headset.

6. The hatset of claim 2 wherein said hat distributes said weight of said headset over the area in which said hat contacts said head of said user.

7. The hatset of claim 2 wherein said hat is securely attachable to said headset part.

8. The hatset of claim 2 wherein said hat is easily and rapidly separable from said headset.

9. The hatset of claim 2 wherein said hat hygienically isolates said user from said headset.

10. The hatset of claim 1 wherein said audio transducer is a speaker.

11. The hatset of claim 1 wherein said transducer is in close proximity to one ear of said user.

12. A hatset for converting electrical signals into corresponding audible signals and for converting an audible signal into a corresponding electrical signal comprising:
a hat worn by a human user;
at least one audio transducer for converting an electrical signal into corresponding sounds audible to said wearer of said hat; and
at least one electrical transducer capable of converting audible sound into a corresponding electrical signal.

13. The hatset of claim 12 wherein said hat is configured to fit said head of said user.

14. The hatset of claim 12 wherein said hat is configured to fit at least two different sizes of user heads.

15. The hatset of claim 12 wherein said transducers are supported by a headset that encircles said head of said user

16. The hatset of claim 13 wherein said hat supports the weight of said headset.

17. The hatset of claim 13 wherein said hat distributes said weight of said headset over the area in which said hat contacts said head of said user.

18. The hatset of claim 13 wherein said headset may be securely attached to said hat.

19. The hatset of claim 13 wherein said hat is easily and rapidly separable from said headset.

20. The hatset of claim 13 wherein said hat hygienically isolates said user from said headset.

21. The hatset of claim 12 wherein said audio transducer is a speaker

22. The hatset of claim 12 wherein said audio transducer is in close proximity to one ear of said user.

23. The hatset of claim 12 wherein said electrical transducer is a directional microphone.

24. The hatset of claim 12 wherein said electrical transducer is positioned in close proximity to the mouth of said user.

25. The hatset of claim 24 wherein said electrical transducer may be moved away from said mouth of said user and later returned precisely to its prior position in close proximity to said mouth of said user.

26. The hatset of claim 13 wherein said audio transducer is connected to said headset by an audio transducer support arm.

27. The headset of claim 13 wherein said electrical transducer is supported by a boom that is rotatably connected to said audio transducer support arm.

28. The hatset of claim 27 wherein said boom and said support arm are fitted with corresponding detents at the point where said boom is rotatably connected to said support arm such that said boom can be rotated away from said mouth of said user and then accurately rotated back into its original position.

29. A hatset for converting electrical signals into corresponding audible signals and for converting audible signals into corresponding electrical signals comprising:
a hat worn by a human user;
a hat insert assembly; and
a headset assembly.

30. The hatset of claim 29 wherein said hat insert assembly comprises a hat insert band attached to said hat and an earpiece support guide attached to said hat insert band.

31. The hatset assembly of claim 30 wherein said headset assembly comprises:
an earpiece support assembly;
an earpiece assembly attached to said earpiece support assembly; and
a microphone boom assembly attached to said earpiece support assembly in proximity to said earpiece assembly.

32. The hatset of claim 31 wherein said microphone boom assembly comprises a microphone and is attached to said earpiece support assembly in proximity to said earpiece assembly.

33. The hatset of claim 32 wherein said microphone boom assembly and said earpiece support assembly are rotatably connected.

34. The hatset of claim 33 wherein said earpiece support assembly comprises:
an earpiece support arm slideably connected to said earpiece support guide;
at least one button affixed to said earpiece support arm; and
a printed circuit board affixed to said earpiece support arm and electrically connected to said at least one button so that at least one function of said hatset may be controlled by said at least one button.

35. The hatset of claim 34 wherein said microphone boom assembly and said earpiece support arm are provided with corresponding detents such that said microphone can be rotated relative to said boom in repeatable and accurate increments.

36. The hatset of claim 35 wherein said earpiece assembly comprises a earpiece housing, which in turn comprises:
a speaker;
a speaker grill;
an inner comfort pad attached to said speaker grill; and
an outer comfort pat attached to said earpiece housing.

37. A method for converting electrical signals into corresponding audible signals, said process comprising the following steps:
affixing at least one transducer to a headset, said transducer being capable of converting an electrical signal to a corresponding audible signal;
affixing said headset to a hat worn by a user so that said transducer is in close proximity to an ear of said user;
providing said transducer with an electrical signal;
converting said electrical signal into a corresponding audible signal that is perceived by said user.

38. The method of claim 37 wherein said hat distributes the weight of said headset over the area in which said hat contacts said head of said user.

39. The method of claim 37 involving the further step of securely attaching said hat to said headset.

40. The method of claim 37 involving the further step of easily and rapidly separating said hat from said headset.

41. The method of claim 37 wherein said hat hygienically isolates said user from said headset.

42. A method for converting audible signals into corresponding electrical signals, said process comprising the following steps:
affixing at least one transducer to a boom rotatably connected to a headset, said transducer being capable of converting an audio signal to a corresponding electrical signal;
affixing said headset to a hat worn by a user so that said transducer is in close proximity to said mouth of said user;
rotating said boom away from said mouth of said user;
rotating said boom accurately back to its position at said mouth of said user;
providing said transducer with an audio signal;
converting said audio signal into a corresponding electrical signal.

43. The method of claim 42 wherein said hat distributes the weight of said headset over the area in which said hat contacts said head of said user.

44. The method of claim 42 involving the further step of securely attaching said hat to said headset.

45. The method of claim 42 involving the further step of easily and rapidly separating said hat from said headset.

46. The method of claim 42 wherein said hat hygienically isolates said user from said headset.

47. A headset for converting audible signals into corresponding electrical signals comprising:
a transducer for converting audible signals into corresponding electrical signals;
a boom for supporting said transducer;
a band on the head of the user for supporting said boom on the head of the user: and
a pivot affixed to said boom and said band such that said boom can rotate relative to said band.

48. The headset of claim 47 wherein said transducer is affixed to said boom at a position spaced from said pivot.

49. The headset of claim 48 wherein said boom is fitted with a first circular toothed ratchet, the teeth of which are disposed in spaced angular intervals and circumferentially disposed relative to said pivot.

50. The headset of claim 49 wherein said band is fitted with a second circular toothed ratchet, the teeth of are disposed in spaced angular intervals and circumferentially disposed relative to said pivot.

51. The headset of claim 50 wherein said first and second ratchets are disposed opposite to one another relative to said pivot such that said teeth of said ratchets mesh with one another.

52. The headset of claim 51 wherein said boom and said band rotate relative to one another in angular increments that correspond to the angular increments of the teeth of said first and second ratchets.

53. The headset of claim 52 wherein said transducer may be positioned in the proximity of a users mouth; rotated to a position that is not proximate to said user's mouth; and rotated to the original position relative to said user's mouth.

54. The headset of claim 52 wherein said boom is connected to said band with a support assembly.

55. The headset of claim 54 wherein said boom may be moved vertically relative to said band, permitting adjustment of said transducer to be proximate to a user's mouth.

56. The headset of claim 55 wherein said support assembly supports a transducer for converting electrical signals into corresponding audible signals.
